(19) United States
(12) Patent Application Publication
(10) Pub. No.: US 2023/0062699 A1
(43) Pub. Date: Mar. 2, 2023

(54) Shelf Stable Aggregate Food Product

(71) Applicant: General Mills, Inc., Minneapolis, MN (US)

(72) Inventors: Emily Fortener, Plymouth, MN (US); Eric Hissam, St. Michael, MN (US); Shintaro Pang, New Hope, MN (US); Nathan Valentine, Eagan, MN (US)

(73) Assignee: General Mills, Inc., Minneapolis, MN (US)

(21) Appl. No.: 17/463,952

(22) Filed: Sep. 1, 2021

(51) Int. Cl. A23L 7/126; A23L 29/25; A23L 29/00; A23L 29/10; A23L 25/00; A23L 19/00; A23P 10/20

(52) U.S. Cl. CPC A23L 7/126; A23L 29/25; A23L 29/035; A23L 29/10; A23L 25/20; A23L 19/05; A23P 10/20; A23V 2002/00

(57) ABSTRACT

Shelf stable aggregate foods are described that include a chewy binder that includes essentially no non-intact sugar sources. A binder in a shelf stable aggregate food remains chewy over shelf life and contains a sprouted whole grain ingredient, gum Arabic, an oil, and glycerin. Also described are methods of making a shelf stable aggregate food.

### BACKGROUND

Consumers enjoy convenient snack foods that provide a variety of eating experiences. Convenient, shelf stable snack foods are available in various forms, such as snack mixes and snack bars. Shelf stable snack foods provide a number of benefits to consumers. They are generally ready-made without requiring refrigeration or preparation; they can often be consumed without needing utensils; and they provide a variety of flavors and textures to satisfy a wide array of cravings. However, as consumers increasingly look for snack options with limited sugar content, snacks in aggregate form often rely on sugar to bind particulates together.

### SUMMARY

The present disclosure relates to a shelf stable, ready-to-eat aggregate snack.

A shelf stable food product is provided herein. The shelf stable food product includes an aggregate of particulates bound together by a pliable binder, where the aggregate includes the particulates in an amount of about 50% to about 70% by weight of the aggregate; and the pliable binder in an amount of about 30% to about 50% by weight of the aggregate, with the pliable binder comprising sprouted whole grain ingredient in an amount of 25% to about 55% by weight of the pliable binder; gum acacia in an amount of 6% to about 18% by weight of the pliable binder, where the ratio of the amount of sprouted whole grain ingredient to the amount of gum acacia is at least 2:1 to about 6:1; oil in an amount of about 12% to 20% by weight of the pliable binder; glycerin in an amount of about 12% to 20% by weight of the pliable binder, where the combined amount oil and glycerin does not exceed 35% by weight of the pliable binder; moisture content of about 8% to less than 25% by weight of the pliable binder; and essentially no non-intact sugar sources.

In some embodiments, the sprouted whole grain ingredient can be included in an amount of about 30% to about 45% by weight of the pliable binder.

In some embodiments, the ratio of sprouted whole grain ingredient to gum acacia can be about 3:1 to about 4:1.

In some embodiments, the oil can be included in an amount of about 14% to about 18% by weight of the pliable binder.

In some embodiments, the glycerin can be included in an amount of about 14% to about 18% by weight of the pliable binder.

In some embodiments, the moisture content can be about 15% to about 20% by weight of the pliable binder.

In some embodiments, the pliable binder can include a fruit powder, such as date powder, in an amount of up to 8% by weight of the pliable binder.

In some embodiments, the combined amount of sprouted whole grain ingredient and amount of fruit powder may not exceed 55% by weight of the pliable binder.

In some embodiments, the pliable binder can include an emulsifier in an amount of about 3% to about 10%, or about 5% to about 8% by weight of the oil.

A method of making a shelf stable food is also provided. The method includes providing a fluid binder at a temperature of about 140° F. to about 200° F.; combining the fluid binder with particulates to produce an aggregate; forming the aggregate into pieces; and setting the fluid binder form a pliable binder, where the pliable binder binds the particulates together in the aggregate to form the shelf stable food, the shelf stable food including the particulates in an amount of about 50% to about 70% by weight of the aggregate and the pliable binder in an amount of about 30% to about 50% by weight of the aggregate. A fluid binder used in a method of making a shelf stable food includes where the fluid binder comprises sprouted whole grain ingredient in an amount of 25% to about 55% by weight of the fluid binder; gum acacia in an amount of 6% to about 18% by weight of the fluid binder, where the ratio of the amount of sprouted whole grain ingredient to the amount of gum acacia is at least 2:1 to about 6:1; oil in an amount of about 12% to 20% by weight of the fluid binder; glycerin in an amount of about 12% to 20% by weight of the fluid binder, where the combined amount oil and glycerin does not exceed 35% by weight of the fluid binder; a moisture content of about 8% to less than 25% by weight of the fluid binder; and essentially no non-intact sugar sources.

In some embodiments, the temperature of the fluid binder can be from about 160° F. to about 180° F.

A method of making a shelf stable food can further include producing the fluid binder using the steps of producing an aqueous composition by combining water, the glycerin, and the gum acacia with sufficient shear to disperse the gum acacia within the water; producing an oil and water composition by combining the aqueous composition with the oil with sufficient shear to produce an unstable emulsion or a stable emulsion; and producing the fluid binder by combining the oil and water composition with the sprouted whole grain ingredient with sufficient shear to homogeneously mix the sprouted whole grain ingredient with the oil and water composition.

In some embodiments, at least the step of combining the oil and water composition with the sprouted whole grain ingredient can be performed at a temperature of about 140° F. to about 200° F.

In some embodiments, the step of producing the oil and water composition can include adding an emulsifier to produce a stable emulsion.

In some embodiments, a fruit powder and/or a flavorant can be combined with the oil and water composition prior to adding the sprouted whole grain ingredient.

These and various other features and advantages will be apparent from a reading of the following detailed description.

### DETAILED DESCRIPTION

Shelf stable snack bar options, such as granola bars, that include aggregates of particulates often rely on sugars and sugar syrups (e.g., corn syrup), which some consumers prefer to avoid, to bind the particulates together. Sugar-based binders also introduce sweetness to such snack bars, which limits the ability to formulate them without adding sugar.

A unique shelf stable food product is described herein. It was discovered, and is disclosed herein, that a shelf stable food product that includes an aggregate containing a food binder containing no non-intact sugar sources that provides an eating experience similar to a sucrose-based chewy binder. Surprisingly, a shelf stable food including such an aggregate remains chewy over shelf life.

As used herein, a “sugar” is a monosaccharide or a disaccharide. As used herein, sources of sugar that are considered intact sugar sources include non-extracted malted or sprouted whole grains; non-concentrated fruit or vegetable purees, pulps, and pastes; concentrated fruit or vegetable purees, pulps, and pastes; fruit or vegetable powder; non-sweetened fruit pieces; non-sweetened dried fruit; the sugar portion of inulin and other fiber ingredients; allulose; and any other sugar sources that are otherwise unrefined. A “non-intact sugar source,” as used herein, refers to fractions, extracts or other derivatives of an intact sugar source that does not contain the entire contents of the intact sugar source, with the exception of water content. As used herein, non-sugar sweeteners, such as sugar alcohols (e.g., erythritol, maltitol, and the like) and high potency sweeteners (e.g., stevia extract, monk fruit extract, sucralose, and the like) are not considered sugars.

A shelf stable food product generally includes an aggregate of particulates (50-70%, or 55% to 65% by weight of the aggregate) bound by a pliable binder (30% to 50%, or 35% to 45% by weight of the aggregate). A shelf stable food typically has a water activity of no more than 0.6 (e.g., less than 0.6, or less than 0.58), and has a shelf life of at least 6 months (e.g., at least 9 months, or at least 12 months) in a package at room temperature.

A pliable binder provided herein includes a sprouted whole grain ingredient, gum acacia, oil, glycerin, and moisture in amounts that enable the pliable binder to provide a chewy texture to an aggregate and remain chewy over shelf life without causing particulates within the aggregate to become soggy.

A pliable binder includes a sprouted whole grain ingredient in an amount of 25% to about 55% (e.g., 30% to about 45%, or about 35% to about 45%) by weight of the pliable binder. A sprouted whole grain ingredient included in a pliable binder contributes to the ability of the binder to hold particulates together. As used herein, a “sprouted whole grain ingredient” refers to an ingredient (e.g., a flour, pulp, puree, powder, paste, or the like) produced from the entire contents of a whole grain (e.g., wheat, oat, rice, barley, or the like) that has been germinated for sufficient time to produce a sprout. That is, a sprouted whole grain ingredient includes the sprout and the seed portion of a grain, including all the contents of the seed portion (e.g., bran, germ, and endosperm). A sprouted whole grain ingredient does not refer to fractions, extracts or other derivatives of a sprouted grain that do not contain the entire sprouted grain contents.

In some embodiments, a suitable sprouted whole grain ingredient includes a sprouted whole grain ingredient having a sugar content of at least 30% (e.g., at least 35%, or from about 35% to about 60%, from about 35% to about 50%, or from about 40% to about 45%) by dry weight of the sprouted whole grain ingredient. In some embodiments, the sugar content of a sprouted whole grain ingredient can include maltose in an amount of at least 70% (e.g., at least 75%, or at least 80%) by weight of the sugar content.

In some embodiments, a suitable sprouted whole grain ingredient includes a sprouted whole grain ingredient having a carbohydrate content of from about 60% to about 90% (e.g., about 70% to about 90%, about 75% to about 90%, or about 80% to about 85%) by dry weight of the sprouted whole grain ingredient. In some embodiments, the carbohydrate content of a sprouted whole grain ingredient can have an average dextrose equivalent (DE) of greater than 30 (e.g., at least 32, from 32 to 40, or from 34 to 38).

In some embodiments, a fruit powder (e.g., a date powder, a fig powder, a banana powder, or the like, or any combination of fruit powders) can be included in a pliable binder. A fruit powder can be included in a pliable binder in an amount of up to 8% (e.g., about 1% to about 6%, or about 2% to about 5%) by weight of the pliable binder. In some embodiments, the combined amount of a fruit powder and amount of a sprouted whole grain ingredient in a pliable binder does not exceed 55% by weight of the pliable binder. A fruit powder included in a pliable binder can add sweetness to a pliable binder. Generally, increasing amounts of fruit powder can contribute increasing levels of viscosity of a pliable binder during production. In some cases, an amount of fruit powder that exceeds 8% by weight of a pliable binder can cause reduced binding and/or increased brittleness of a pliable binder over shelf life.

A pliable binder includes gum acacia in an amount of 6% to about 18% (e.g., about 8% to about 15%, or about 10% to about 13%) by weight of the pliable binder. Gum acacia included in a pliable binder contributes to the ability of the binder to remain pliable over shelf life without interfering with binding of particulates together. In addition, an amount of gum acacia included at a ratio of at least 2:1 to about 6:1 (e.g., about 3:1 to about 4:1) relative to the amount of sprouted whole grain ingredient included in a pliable binder provides a good balance of chewiness and binding over shelf life, and viscosity during production.

A pliable binder includes oil in an amount of about 12% to about 20% (e.g., about 14% to about 18%) by weight of the pliable binder. Oil included in a pliable binder contributes to the ability of the binder to remain pliable over shelf life without interfering with binding of particulates together. Oil in a pliable binder may also contribute to preventing particulates from becoming soggy over shelf life. An amount of oil exceeding 20% by weight of a pliable binder may result in an aggregate in a shelf stable food that is too loose and more likely to break or pull apart during shelf life. Any appropriate oil can be used in a pliable binder, such as canola oil, soybean oil, sunflower oil, and the like, or any combination of oils.

In some embodiments, a pliable binder can contain an emulsifier in an amount of up to 10% (e.g., about 3% to about 10%, or about 5% to about 8%) by weight of the amount of oil included in the pliable binder. While not essential, an emulsifier can improve processing while manufacturing a shelf stable food provided herein. In some cases, an emulsifier can reduce oil separation from an aggregate over shelf life.

A pliable binder includes glycerin in an amount of about 12% to about 20% (e.g., about 14% to about 18%) by weight of the pliable binder. Glycerin included in a pliable binder contributes to the ability of the binder to remain pliable over shelf life without contributing to an oily texture. In addition, glycerin can help contribute to a mouthfeel that is perceived as moist while keeping a water activity within the desired range. In some embodiments, the combined amount of glycerin and amount of oil in a pliable binder does not exceed 35% by weight of the pliable binder. In some embodiments the ratio of the amount of glycerin included in a pliable binder relative to the amount of oil can be about 1:2 to about 2:1 (e.g., about 1:1).

A pliable binder provided herein typically has a moisture content of about 8% to less than 25% (e.g., about 15% to about 20%). Moisture content in a pliable binder can be contributed by the inclusion of water as an ingredient and/or water content in any of the other included ingredients. Such a moisture content can contribute to a water activity within the desired range, and chewiness over shelf life without resulting in sogginess of particulates within an aggregate. In addition, a moisture content of from about 8% to less than 25% can enable a pliable binder to be used in an aggregate without requiring drying and/or baking to achieve effective binding.

In some embodiments, a pliable binder can contain other ingredients, such as flavorants (e.g., vanilla, cinnamon, salt, and the like), colorants, and preservatives (e.g., citric acid, and the like). Although it is preferred that the sprouted whole grain ingredient and the optional fruit powder provide the entirety of sweetness in a food product provided herein, in some embodiments, a high intensity sweetener (e.g., stevia extract or monk fruit extract) can be included. Preferably, other ingredients included in a pliable binder do not contribute non-intact sugar sources to the pliable binder. Typically, such other ingredients are included in minor amounts (e.g., less than 2% each, or less than 1.75% each). In some embodiments, all combined ingredients included in a pliable binder other than a sprouted whole grain ingredient, gum acacia, oil, glycerin, water, fruit powder, and emulsifiers, do not exceed 8% (e.g., do not exceed 5%) by weight of the pliable binder.

Particulates suitable for combining with a pliable binder to produce an aggregate include any shelf-stable edible particulates, such as seeds, rolled grains, puffed grains, puffed protein bits, nuts or nut pieces, dried fruit, or the like, or any combination thereof. Advantageously, an aggregate that includes a pliable binder described herein can contain particulates that readily absorb water, such as rolled grains, puffed grains, and puffed protein bits, without becoming soggy over shelf life. As such, crispy and crunchy particulates can provide a pleasing contrast to a chewy texture contributed by a pliable binder over shelf life.

In some embodiments, all of the ingredients of a pliable binder provided herein can be considered organic. In some embodiments, all of the ingredients in an entire shelf stable food product provided herein can be considered organic.

Methods of making a shelf stable food are also provided herein. Generally, a method includes providing a fluid binder with an ingredient makeup of a pliable binder described above at a temperature of about 140° F. to about 200° F. (e.g., about 160° F. to about 180° F.). Such a temperature maintains a pliable binder in a fluid state at a viscosity that is suitable for handling using standard food manufacturing equipment, such as pumps, mixers, and the like. At temperatures exceeding 200° F., a fluid binder (and thus, a pliable binder) may experience changes in flavor, while at temperatures below 140° F., a fluid binder may be too viscous to pump and/or mix with particulates.

A fluid binder can be made by combining ingredients in the amounts and ratios described above for a pliable binder. A particularly suitable method of making a fluid binder includes producing an aqueous composition by combining water, glycerin, and gum acacia with sufficient shear to disperse the gum acacia within the water. This step can initiate hydration of the gum acacia, but it is not necessary to achieve full hydration of the gum acacia. Thus, it only sufficient shear and time is necessary to disperse the gum acacia within the water.

An oil and water composition can be produced by combining an aqueous composition with oil with sufficient shear to disperse the oil in the water. An oil and water composition can comprise an unstable emulsion, or optionally, an emulsifier can be added during this step to create a stable emulsion. An emulsifier can be added to the oil or to the aqueous composition before combining the oil and aqueous composition, or it can be added after the oil and the aqueous composition are combined. Preferably, an emulsifier is added prior to applying shear in order to facilitate development of an emulsion.

An oil and water composition can be combined with a sprouted whole grain ingredient with sufficient shear to homogeneously mix the sprouted whole grain ingredient with the oil and water composition to produce a fluid binder. Optionally, the oil and water composition can be combined with a fruit powder and/or other ingredients (e.g., flavorants, colorants, preservatives, and the like) prior to combining with a sprouted whole grain ingredient. Generally, it is preferred that a sprouted whole grain ingredient is added as the last ingredient of a fluid binder to control viscosity development during production.

A fluid binder can be produced using any appropriate equipment, such as a batch mixer. In some embodiments, one or more steps of making a fluid binder can be performed at a temperature of 140° F. to about 200° F. (e.g., about 160° F. to about 180° F.) to help control viscosity during production.

A fluid binder is combined with particulates to produce an aggregate with the particulates making up about 50% to about 70% (e.g., about 55% to about 65%) by weight of the aggregate and the fluid binder making up about 30% to about 50% (e.g., about 35% to about 45%) by weight of the aggregate. A fluid binder is generally combined with particulates with sufficient mixing to achieve coating of the particulates such that they will bind together upon setting of the fluid binder.

Aggregate is then formed into pieces (e.g., bites, bars, or the like), and the fluid binder is set to form a pliable binder. Advantageously, a fluid binder can be set by cooling the fluid binder (e.g., to less than 140° F., less than 100° F., or to room temperature) to form a pliable binder that functions to bind particulates together.

An aggregate can be packaged alone or in combination with one or more additional food ingredients, such as a coating or a drizzle, to produce a shelf stable food product. A shelf stable food product can be packaged in any appropriate packaging material, such as a plastic, foil, or paper-based wrapper.

The implementations described above and other implementations are within the scope of the following claims. One skilled in the art will appreciate that the present disclosure can be practiced with embodiments other than those disclosed. The disclosed embodiments are presented for purposes of illustration and not limitation.

What is claimed is:

1. A shelf stable food product, comprising an aggregate of particulates bound together by a pliable binder, the aggregate including:
a. the particulates in an amount of about 50% to about 70% by weight of the aggregate; and
b. the pliable binder in an amount of about 30% to about 50% by weight of the aggregate, the pliable binder comprising:
i. sprouted whole grain ingredient in an amount of 25% to about 55% by weight of the pliable binder;
ii. gum acacia in an amount of 6% to about 18% by weight of the pliable binder, wherein the ratio of the amount of sprouted whole grain ingredient to the amount of gum acacia is at least 2:1 to about 6:1;
iii. oil in an amount of about 12% to 20% by weight of the pliable binder;
iv. glycerin in an amount of about 12% to 20% by weight of the pliable binder, wherein the combined amount oil and glycerin does not exceed 35% by weight of the pliable binder;
v. moisture content of about 8% to less than 25% by weight of the pliable binder; and
vi. essentially no non-intact sugar sources.

2. The shelf stable food product of claim 1, wherein the sprouted whole grain ingredient is included in an amount of about 30% to about 45% by weight of the pliable binder.

3. The shelf stable food product of claim 1, wherein the ratio of sprouted whole grain ingredient to gum acacia is about 3:1 to about 4:1.

4. The shelf stable food product of claim 1, wherein the oil is included in an amount of about 14% to about 18% by weight of the pliable binder.

5. The shelf stable food product of claim 1, wherein the glycerin is included in an amount of about 14% to about 18% by weight of the pliable binder.

6. The shelf stable food product of claim 1, wherein the moisture content is about 15% to about 20% by weight of the pliable binder.

7. The shelf stable food product of claim 1, wherein the pliable binder comprises a fruit powder in an amount of up to 8% by weight of the pliable binder.

8. The shelf stable food product of claim 7, wherein the combined amount of sprouted whole grain ingredient and amount of fruit powder does not exceed 55% by weight of the pliable binder.

9. The shelf stable food product of claim 7, wherein the fruit powder comprises date powder.

10. The shelf stable food product of claim 1, wherein the pliable binder comprises an emulsifier in an amount of about 3% to about 10% by weight of the oil.

11. The shelf stable food product of claim 10, wherein the emulsifier is included in an amount of about 5% to about 8% by weight of the oil.

12. A method of making a shelf stable food, the method including:
a. providing a fluid binder at a temperature of about 140° F. to about 200° F., the fluid binder comprising:
i. sprouted whole grain ingredient in an amount of 25% to about 55% by weight of the fluid binder;
ii. gum acacia in an amount of 6% to about 18% by weight of the fluid binder, wherein the ratio of the amount of sprouted whole grain ingredient to the amount of gum acacia is at least 2:1 to about 6:1;
iii. oil in an amount of about 12% to 20% by weight of the fluid binder;
iv. glycerin in an amount of about 12% to 20% by weight of the fluid binder, wherein the combined amount oil and glycerin does not exceed 35% by weight of the fluid binder;
v. moisture content of about 8% to less than 25% by weight of the fluid binder; and
vi. essentially no non-intact sugar sources; and
b. combining the fluid binder with particulates to produce an aggregate;
c. forming the aggregate into pieces; and
d. setting the fluid binder form a pliable binder, wherein the pliable binder binds the particulates together in the aggregate to form the shelf stable food, the shelf stable food including the particulates in an amount of about 50% to about 70% by weight of the aggregate and the pliable binder in an amount of about 30% to about 50% by weight of the aggregate.

13. The method of claim 12, wherein the temperature of the fluid binder is from about 160° F. to about 180° F.

14. The method of claim 12, further comprising producing the fluid binder using the steps of:
a. producing an aqueous composition by combining water, the glycerin, and the gum acacia with sufficient shear to disperse the gum acacia within the water;
b. producing an oil and water composition by combining the aqueous composition with the oil with sufficient shear to produce an unstable emulsion or a stable emulsion; and
c. producing the fluid binder by combining the oil and water composition with the sprouted whole grain ingredient with sufficient shear to homogeneously mix the sprouted whole grain ingredient with the oil and water composition.

15. The method of claim 14, wherein at least the step of combining the oil and water composition with the sprouted whole grain ingredient is performed at a temperature of about 140° F. to about 200° F.

16. The method of claim 14, wherein the step of producing the oil and water composition comprises adding an emulsifier to produce a stable emulsion.

17. The method of claim 14, wherein a fruit powder and/or a flavorant is combined with the oil and water composition prior to adding the sprouted whole grain ingredient.
